(19) United States
(12) Patent Application Publication
(10) Pub. No.: US 2003/0233294 A1
(43) Pub. Date: Dec. 18, 2003

(54) System and method for managing delayed orders

(76) Inventors: Sheng Chi Luo, Tu-Chen (TW); Wen Bo Mao, Shenzhen (CN); Qiong Shuai Chen, Shenzhen (CN)

Correspondence Address: WEI TE CHUNG, FOXCONN INTERNATIONAL, INC., 1650 MEMOREX DRIVE, SANTA CLARA, CA, 95050, US

(21) Appl. No.: 10/280,614

(22) Filed: Oct. 25, 2002

(30) Foreign Application Priority Data
Jun. 13, 2002 (TW) 091112870

(51) Int. Cl. G06F 17/60

(52) U.S. Cl. 705/28

(57) ABSTRACT

A system and method for managing delayed purchase orders according to inventory data, work in progress data and scheduled production data. The system comprises a main database (4); an application server (2) electronically connecting with the main database, for automatically integrating data received from a plurality of databases, and transmitting the integrated data to the main database and a web server (3) electronically connecting with the main database for users to access and process data stored in the main database. The web server comprises a main control unit (30) for processing the data stored in the main database. The main control unit comprises: a report output module (340) for automatically generating shipping dates of delayed purchase orders according to data stored in the main database, and for outputting reports on shipping dates of delayed purchase orders; and an auto-mail module (350) for automatically sending messages to designated electronic mail addresses.

### BACKGROUND OF THE INVENTION

1. Field of the Invention

This invention relates to systems and methods for managing delayed purchase orders, and more particularly to systems and methods which can integrate inventory data and production data to automatically schedule shipment of delayed purchase orders.

2. Description of Related Art

A large manufacturing enterprise is often not able to fulfill certain purchase orders in time, particularly purchase orders for relatively small amounts of goods. Such purchase orders are too often neglected by production departments if customers do not follow them up. Especially during peak production periods, these purchase orders are liable to be delayed. If the delay is extensive, the purchase order may even be canceled.

In addition, some manufacturing enterprises do not have an efficient computer system for managing received purchase order data and production. For example, communication between a production department and a sales department may be slow and cumbersome. As a result, some purchase orders that could be fulfilled by inventory are nevertheless delayed. In addition, a production department may lie idle even though a sales department is holding a purchase order requiring production.

Moreover, raw materials needed for delayed purchase orders are frequently reserved for use in fulfilling other ordinary purchase orders. Replenishment of such raw materials to enable fulfillment of delayed purchase orders is not adequately organized.

Accordingly, what is needed is a system and method which can overcome the abovementioned problems.

### SUMMARY OF THE INVENTION

A primary object of the present invention is to provide a system which integrates inventory data and production data to schedule shipment of delayed purchase orders.

Another object of the present invention is to provide a method which integrates inventory data and production data to schedule shipment of delayed purchase orders.

To achieve the above-mentioned primary object, a system of the present invention for managing delayed purchase orders comprises a main database; an application server electronically connecting with the main database, for automatically integrating data received from a plurality of databases, and for transmitting the integrated data to the main database; and a web server electronically connecting with the main database for users to access and process data stored in the main database, the web server comprising a main control unit for processing the data stored in the main database. The main control unit comprises a report output module for automatically generating shipping dates of delayed purchase orders according to data stored in the main database and for outputting reports on shipping dates of delayed purchase orders, an auto-mail module for automatically sending messages to designated electronic mail addresses, an order management module for managing purchase order data stored in the main database, an inventory management module for managing inventory data stored in the main database, a work in progress management module for managing work in progress data stored in the main database, and a user setting module for users to set conditions of implementing the system.

To achieve the other above-mentioned object, a method of the present invention for managing delayed purchase orders comprises the following steps: listing delayed purchase orders in descending order of delayed time; retrieving the delayed purchase orders sequentially; scheduling shipment of the delayed purchase orders according to inventory data, work in progress data and scheduled production data stored in a main database; and updating the main database.

Other objects, advantages and novel features of the present invention will be drawn from the following detailed description of a preferred embodiment of the present invention with attached drawings, in which:

### BRIEF DESCRIPTION OF THE DRAWINGS

FIG. 1 is a schematic diagram of infrastructure of a delayed order management system according to a preferred embodiment of the present invention;

FIG. 2 is a schematic diagram of main application modules of a main control unit of a web server of the system of FIG. 1;

FIG. 3 illustrates an exemplary report created by a report output module of the main control unit shown in FIG. 2;

FIG. 4 is a flowchart of scheduling delayed purchase orders and outputting reports according to the preferred embodiment of the present invention; and

FIG. 5 is a detailed flowchart of scheduling a delayed purchase order according to the preferred embodiment of the present invention.

### DETAILED DESCRIPTION OF THE INVENTION

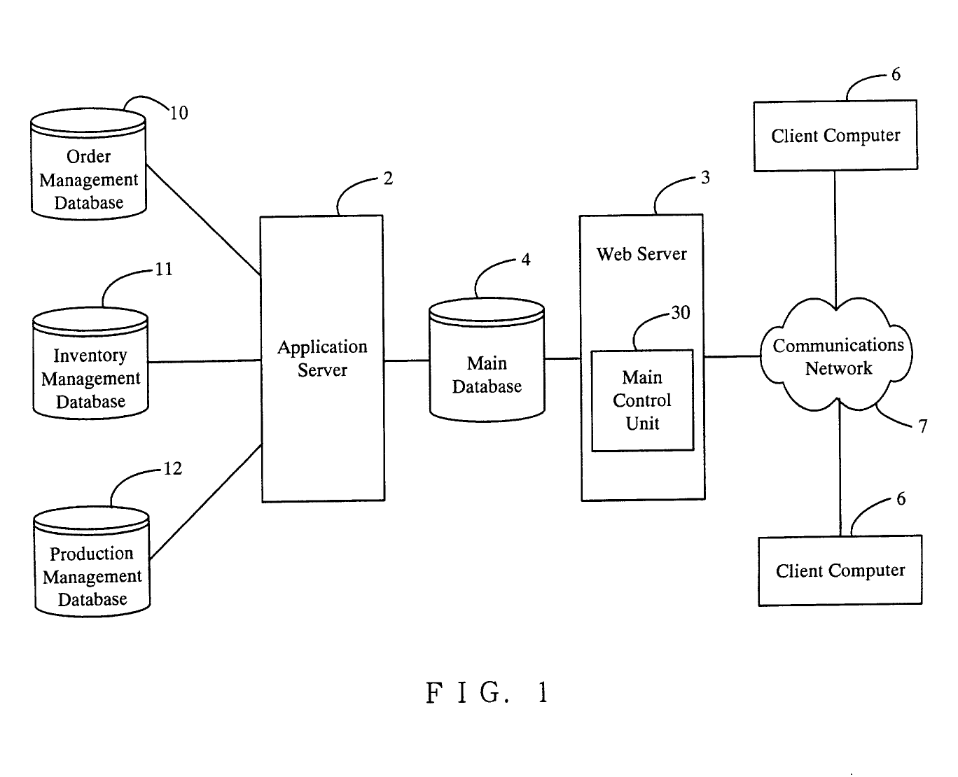

FIG. 1 is a schematic diagram of infrastructure of a delayed order management system according to a preferred embodiment of the present invention. The delayed order management system comprises an application server 2 for integrating data from different databases, a main database 4 for storing integrated data sent from the application server 2, and a web server 3 provided for authorized users to access and handle data stored in the main database 4. A plurality of client computers 6 is connected with the web server 3 via a communications network 7. The communications network 7 can be the Internet or an intranet. The client computers 6 are located in relevant departments of an enterprise that implements the delayed order management system.

An order management database 10 is electronically connected with the application server 2 via an intranet (not labeled), and comprises data on orders. The order management database 10 is generally located in a sales department of the enterprise, and is timely updated when a new order is received or an old order is fulfilled. The application server 2 periodically retrieves and replicates the data on orders from the order management database 10 to the main database 4.

An inventory management database 11 is provided for storing data on available inventory of the enterprise. The inventory management database 11 is generally located in an inventory management department of the enterprise, and is electronically connected with the application server 2 via the intranet (not labeled). The application server 2 periodically retrieves and replicates the data on available inventory from the inventory management database 10 to the main database 4.

A production management database 12 is for storing data on production of the enterprise. The data on production include work in progress (WIP) data, scheduled production data, and production capability data. The production management database 12 is located in a production department of the enterprise, and is electronically connected with the application server 2 via the intranet (not labeled). The application server 2 periodically retrieves and replicates the data on production from the production management database 10 to the main database 4.

The web server 3 comprises a main control unit 30 for controlling operations concerning the data stored in the main database 4.

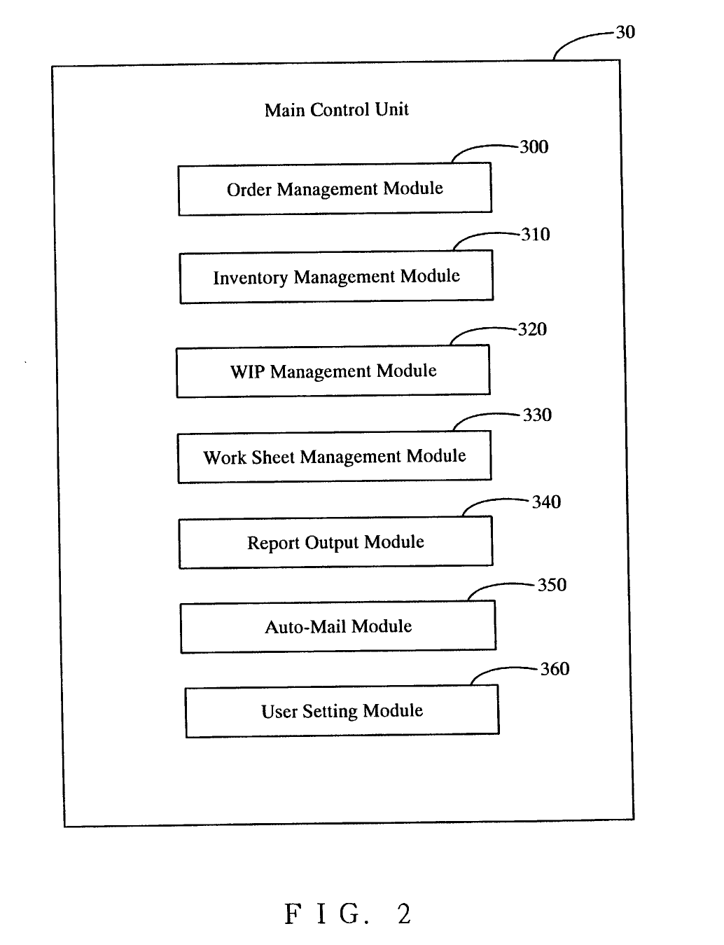

FIG. 2 is a schematic diagram of main application modules of the main control unit 30 of the web server 3. The main control unit 30 comprises an order management module 300, an inventory management module 310, a work in process (WIP) management module 320, a work sheet management module 330, a report output module 340, an auto-mail module 350, and a user setting module 360. The order management module 300 is for managing order data stored in the main database 4. An authorized user can search for and modify order data via the order management module 300. The inventory management module 310 is for managing inventory data stored in the main database 4. The WIP management module 320 is for managing WIP data stored in the main database 4. The work sheet management module 330 is for managing work sheets of scheduled production data stored in the database 4. Authorized users can access the above-mentioned data via the corresponding modules.

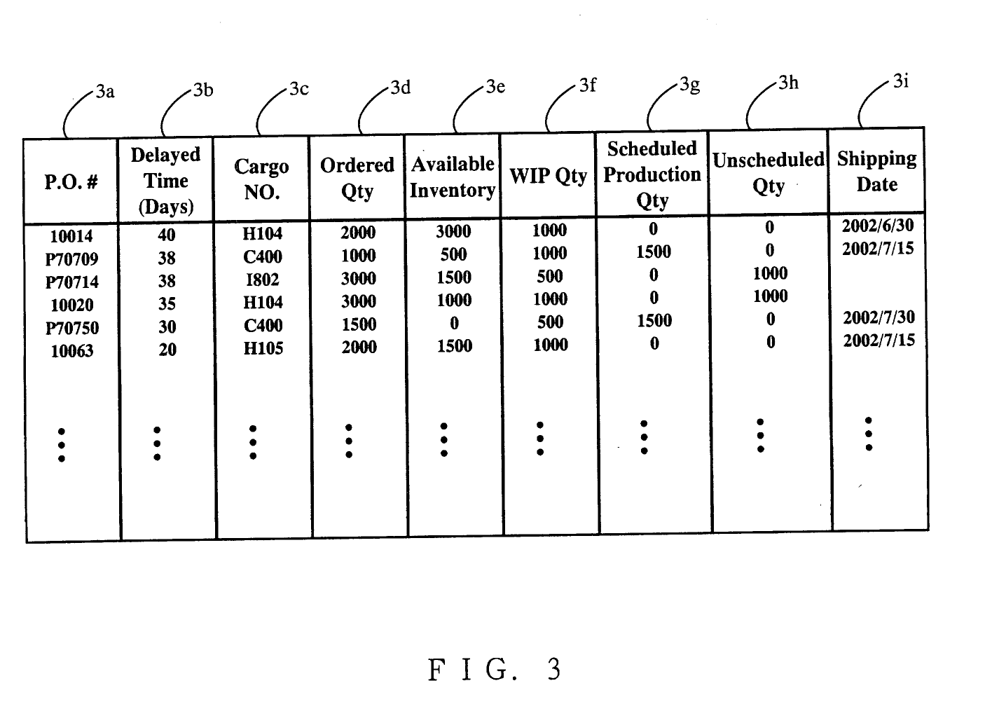

The report output module 340 is for outputting reports on delayed orders. The reports on delayed orders comprise data such as delayed order data, inventory data, WIP data, scheduled production data, and available shipping dates. Delayed orders are listed in the reports in order of descending delayed time. An order having a longer delayed time is scheduled for production and shipment in priority to orders having shorter delayed times. A detailed description of the reports is given below with reference to FIG. 3.

The auto-mail module 350 provides a function of automatically sending electronic mails to relevant departments or staff of the enterprise when an order is scheduled or an order cannot be fulfilled. For example, when the shipping date of an order is scheduled, e-mail is automatically sent to a shipping department of the enterprise. Similarly, if an order cannot be fulfilled by existing inventory and WIP, e-mail is automatically sent to a production planning department of the enterprise.

The user setting module 360 is provided for users to set conditions of implementing the delayed order management system. An authorized user can set conditions such as auto-mail addresses and auto-mail time intervals. Auto-mail addresses show electronic mail addresses that the delayed order management system sends mail to when an order is scheduled or an order cannot be fulfilled. If a delayed order is not scheduled, the auto-mail module 350 continues sending e-mail to relevant departments or staff at set time intervals. For example, the set time intervals may be every 2 days.

FIG. 3 illustrates an exemplary report created by the report output module 340 for recording delayed orders. The report includes a plurality of columns. The columns include a purchase order (P.O.) number 3a, a delayed time 3b, a cargo number 3c, an ordered quantity 3d, an available inventory 3e, a work in progress (WIP) quantity 3f, a scheduled production quantity 3g, an unscheduled quantity 3h, and a shipping date 3i. The purchase order number 3a shows all delayed purchase orders, and the delayed time 3b shows delayed times of the delayed purchase orders. The purchase orders shown in column 3a are listed in descending order of delayed time. A purchase order with a longer delayed time is listed with priority over a purchase order with a shorter delayed time. The cargo number 3c shows cargo numbers of cargo ordered by the corresponding delayed purchase orders listed in column 3a. The ordered quantity 3d shows quantity of the ordered cargo of each delayed purchase order. The available inventory 3e shows quantity of inventory available for corresponding ordered cargo listed in column 3d. When a purchase order having lower priority requires a same kind of cargo as a purchase order having higher priority, the quantity of the available inventory 3e for the lower priority purchase order is discounted to take into account the quantity of the available inventory 3e for the higher priority purchase order. For example, a purchase order “A” requires cargo “X” comprising 2000 pieces, and available inventory of cargo “X” is 3000 pieces. The available inventory can completely fulfill purchase order “A,” with 1000 pieces of cargo “X” remaining available. If another purchase order “B” having lower priority than purchase order “A” also requires cargo “X,” the quantity of available inventory shown in column 3e for purchase order “B” is 1000 pieces. The WIP quantity 3f shows quantities of ordered cargo that is in the process of being manufactured. The scheduled production quantity 3g shows quantities of ordered cargo that are scheduled for production according to work sheets. The unscheduled quantity 3h shows quantities of ordered cargo that are still not scheduled for production. If a purchase order can be fulfilled by available inventory, WIP quantity and scheduled production quantity, the unscheduled quantity of the purchase order is zero. If the total of the available inventory, the WIP quantity and the scheduled production quantity is less than the quantity ordered by the purchase order, the shortfall is shown in the unscheduled quantity 3h. The shipping date 3i shows dates on which cargo ordered by the purchase orders can be delivered.

If the unscheduled quantity of a purchase order is zero, the shipping date of the purchase order is set according to the available inventory, WIP quantity and scheduled production quantity. For instance, 3000 pieces of cargo “X” are ordered by a purchase order. If available inventory of cargo “X” is 3000 pieces or more, the shipping date of the purchase order is scheduled according to an earliest available shipping date, and an e-mail on the shipping date is automatically sent to the shipping department by the auto-mail module 350 (see FIG. 2). If available inventory is not sufficient to fulfill the purchase order, the shipping date of the purchase order is scheduled according to finishing dates of WIP and scheduled production.

If the unscheduled quantity for a purchase order is greater than zero, an e-mail on the unscheduled quantity is sent to the production planning department by the auto-mail module 350 (see FIG. 2).

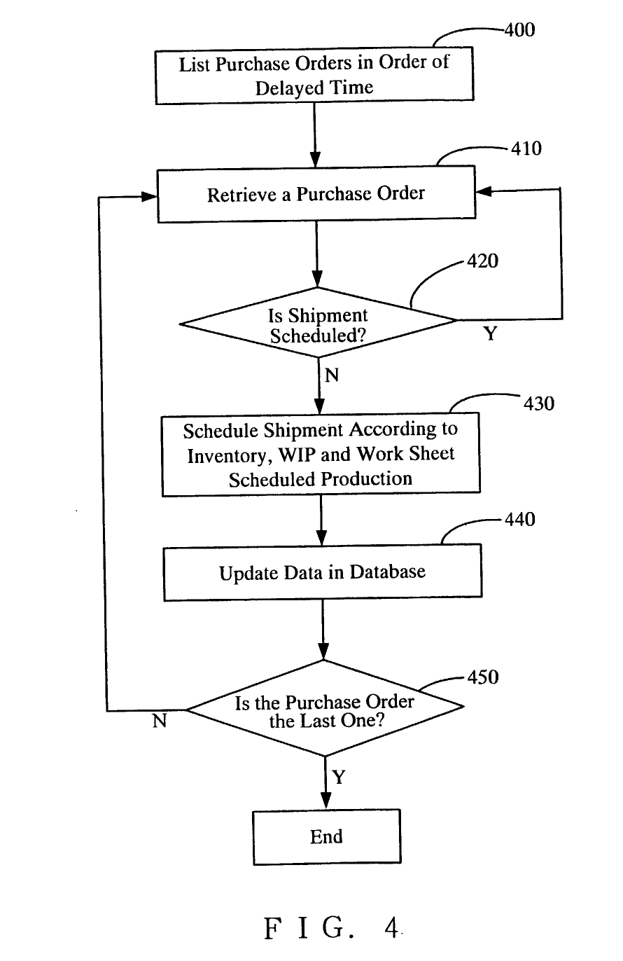

FIG. 4 is a flowchart of scheduling delayed purchase orders and outputting reports according to the preferred embodiment of the present invention. In step 400, all delayed purchase orders are listed in descending order of delayed time. A purchase order with a longer delayed time is handled first. In step 410, data on a purchase order are retrieved from the purchase order list. In step 420, the delayed order management system checks if shipment of the purchase order is scheduled. If shipment of the purchase order is scheduled, then the procedure returns to step 410, and the next purchase order is retrieved from the purchase order list. If shipment of the purchase order is not scheduled, then in step 430 the delayed order management system schedules shipment of the purchase order according to available inventory, WIP quantity and scheduled production quantity. In step 440, data in the main database 4 are updated. That is, data on available inventory, WIP quantity and scheduled production quantity are adjusted according to the requirements of the purchase order. For example, available inventory, WIP quantity and scheduled production quantity of cargo “X”are respectively 2000 pieces, 2000 pieces and 1000 pieces. If 3000 pieces of cargo “X” are ordered by a purchase order, after shipment of the purchase order is scheduled, the up-to-date quantities stored in the main database 4 are respectively 0 pieces, 1000 pieces and 1000 pieces. In step 450, the delayed order management system checks if the purchase order is the last one in the purchase order list. If the purchase order is not the last one, then the procedure returns to step 410 and the next purchase order is retrieved. If the purchase order is the last one, then the procedure is ended.

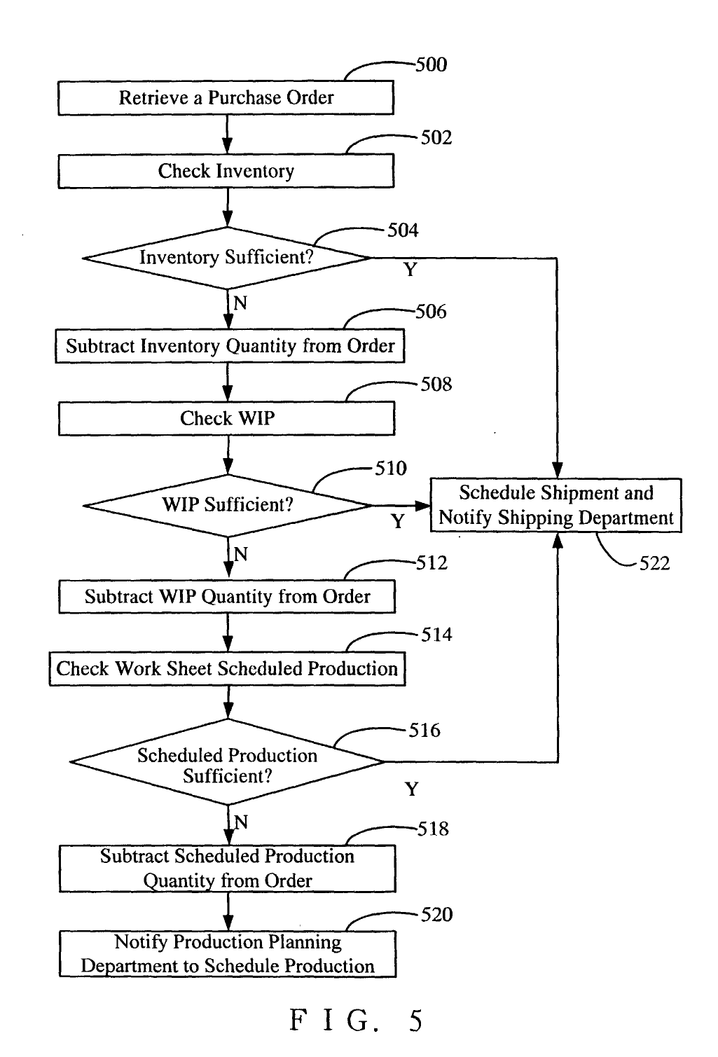

FIG. 5 is a detailed flowchart of scheduling a delayed purchase order according to the preferred embodiment of the present invention. In step 500, data on a delayed purchase order are retrieved from the main database 4. In step 502, the delayed order management system checks inventory data stored in the main database 4. In step 504, the delayed order management system determines whether a quantity of available inventory is sufficient to fulfill the purchase order. If the quantity of available inventory is sufficient to fulfill the purchase order, then in step 522 the delayed order management system schedules shipment of the purchase order and automatically notifies a relevant shipping department by email. If the quantity of available inventory is not adequate to fulfill the purchase order, then in step 506 the quantity of available inventory is subtracted from the quantity required by the purchase order. In step 508, the delayed order management system checks WIP data stored in the main database 4. In step 510, the delayed order management system determines if a quantity of WIP is sufficient to fulfill the purchase order. If the quantity of WIP is sufficient to fulfill the purchase order, then in step 522 the delayed order management system schedules shipment of the purchase order and automatically notifies the relevant shipping department by e-mail. If the quantity of WIP is not sufficient to fulfill the purchase order, then in step 512 the quantity of WIP is subtracted from the quantity required by the purchase order. In step 514, the delayed order management system checks work sheet scheduled production data stored in the main database 4. In step 516, the delayed order management system determines if a quantity of work sheet scheduled production is sufficient to fulfill the purchase order. If the quantity of work sheet scheduled production is sufficient to fulfill the purchase order, then in step 522 the delayed order management system schedules shipment of the purchase order and automatically notifies the relevant shipping department by e-mail. If the quantity of work sheet scheduled production is not sufficient to fulfill the purchase order, then in step 518 the quantity of work sheet scheduled production is subtracted from the quantity required by the purchase order. In step 520, the delayed order management system automatically notifies a relevant production planning department by e-mail for that department to schedule production of an outstanding quantity of cargo required by the purchase order.

The preferred embodiment described herein is merely illustrative of the principles of the present invention. Other arrangements and advantages may be devised by those skilled in the art without departing from the spirit and scope of the present invention. Accordingly, the present invention should be deemed not to be limited to the above detailed description, but rather by the spirit and scope of the claims which follow and their equivalents.

What is claimed is:

1. A system for managing delayed purchase orders, comprising:
a main database;
an application server electronically connecting with the main database, for automatically integrating data received from a plurality of databases, and for transmitting the integrated data to the main database; and
a web server electronically connecting with the main database for users to access and process data stored in the main database, the web server comprising a main control unit for processing the data stored in the main database, the main control unit comprising:
a report output module for automatically generating shipping dates of delayed purchase orders according to data stored in the main database, and for outputting reports on shipping dates of delayed purchase orders; and
an auto-mail module for automatically sending messages to designated electronic mail addresses.

2. The system as claimed in claim 1, wherein the data stored in the main database comprise purchase order data, inventory data, work in progress data and scheduled production data.

3. The system as claimed in claim 1, wherein the main control unit further comprises an order management module for managing purchase order data stored in the main database.

4. The system as claimed in claim 1, wherein the main control unit further comprises an inventory management module for managing inventory data stored in the main database.

5. The system as claimed in claim 1, wherein the main control unit further comprises a work in progress management module for managing work in progress data stored in the main database.

6. The system as claimed in claim 1, wherein the main control unit further comprises a user setting module for users to set conditions of implementing the system.

7. The system as claimed in claim 1, wherein the web server is connected with at least one client computer via a communications network, for providing access to the web server.

8. A method for managing delayed purchase orders, the method comprising the following steps:
listing delayed purchase orders in descending order of delayed time;
retrieving the delayed purchase orders sequentially;
scheduling shipment of the delayed purchase orders according to inventory data, work in progress data and scheduled production data stored in a main database; and
updating the main database.

9. The method as claimed in claim 8, wherein the step of scheduling shipment of the delayed purchase orders comprises the steps of:
checking the inventory data according to requirements of a delayed purchase order;
scheduling shipment of the purchase order when available inventory is sufficient to fulfill the purchase order;
subtracting a quantity of available inventory from a quantity required by the purchase order when the available inventory is not sufficient to fulfill the purchase order;
checking the work in progress data according to the quantity required by the purchase order;
scheduling shipment of the purchase order when work in progress is sufficient to fulfill the purchase order;
subtracting a quantity of work in progress from the quantity required by the purchase order when the work in progress is not sufficient to fulfill the purchase order;
checking the scheduled production data according to the quantity required by the purchase order;
scheduling shipment of the purchase order when the scheduled production is sufficient to fulfill the purchase order; and
subtracting a quantity of schedule production from the quantity required by the purchase order when the scheduled production is not sufficient to fulfill the purchase order.

10. The method as claimed in claim 8, further comprising the step of:
automatically notifying at least one relevant department and/or person when a quantity required by a delayed purchase order is not fulfilled by inventory, work in progress and scheduled production.

11. A method for managing delayed purchase orders, the method comprising the following steps:
retrieving data on a delayed purchase order from a main database;
checking inventory data stored in the main database according to requirements of the purchase order;
scheduling shipment of the purchase order when available inventory meets the requirements of the purchase order;
subtracting a quantity of available inventory from the requirements of the purchase order when the available inventory does not meet the requirements of the purchase order;
checking work in progress data in the main database according to outstanding requirements of the purchase order;
scheduling shipment of the purchase order when work in progress meets the outstanding requirements of the purchase order;
subtracting a quantity of work in progress from the outstanding requirements of the purchase order when the work in progress does not meet the outstanding requirements of the purchase order;
checking scheduled production data in the main database according to still outstanding requirements of the purchase order;
scheduling shipment of the purchase order when scheduled production meets the still outstanding requirements of the purchase order;
subtracting a quantity of scheduled production from the still outstanding requirements of the purchase order and automatically notifying relevant departments and/or persons when the scheduled production does not meet the still outstanding requirements of the purchase order; and
updating the inventory data, the work in progress data and the scheduled production data in the main database.

12. A method for wholly and individually managing delayed purchase orders comprising steps of:
retrieving data on different delayed purchase order from a main database;
arranging delayed purchase orders in sequence according to urgencies thereof; and
scheduling shipments of the purchase orders according to the sequence of said delayed purchase orders; wherein
for each specific purchase order, the shipment is allowed to be scheduled based upon three categories, i.e., inventory data, work in progress data and scheduled production data, stored in the main database in order if at least one of said three categories, individually or accumulatively with the precedent category or categories, can meet requirements of said specific purchase order; wherein
additionally arranging a scheduled production for said specific purchase order if a total amount from these three categories can not meet the requirements of said specific purchase order.
